(19) United States
(12) Patent Application Publication
(10) Pub. No.: US 2020/0045712 A1
(43) Pub. Date: Feb. 6, 2020

(54) BASE STATION, TERMINAL APPARATUS, METHOD, PROGRAM, AND RECORDING MEDIUM

(71) Applicant: NEC CORPORATION, Tokyo (JP)

(72) Inventor: Shizen SASAKI, Tokyo (JP)

(73) Assignee: NEC CORPORATION, Tokyo (JP)

(21) Appl. No.: 16/340,285

(22) PCT Filed: Oct. 2, 2017
(86) PCT No.: PCT/JP2017/035842

§ 371 Date: Apr. 8, 2019

(30) Foreign Application Priority Data
Nov. 1, 2016 (JP) 2016-214086

(51) Int. Cl. H04W 72/08; H04W 52/24; H04L 27/26

(52) U.S. Cl. CPC H04W 72/082; H04W 88/08; H04L 27/2602; H04W 52/243

(57) ABSTRACT

An example object is to make it possible to more flexibly perform interference suppression for a single resource element in a communication scheme in which symbols are mapped to resource elements arranged in frequency direction and time direction. A base station 100 includes a control information obtaining section 133 configured to obtain control information related to the number N of interfering resource elements that are subject to interference suppression for a target resource element (m₀, n₀), and a control information transmission section 135 configured to transmit the control information to a terminal apparatus 200.

### BACKGROUND

### Technical Field

The present invention relates to a base station, a terminal apparatus, a method, a program, and a recording medium.

### Background Art

For example, communication schemes which map symbols to non-orthogonal resource elements arranged in frequency direction and time direction such as Filter Bank Multi-Carrier/Offset Quadrature Amplitude Modulation (FBMC/OQAM) are known.

In such communication schemes, focusing on a single resource element, the single resource element will suffer from an interference from adjacent resource elements regardless of channel fluctuation and presence or absence of noises. For example, in a case where reference signals suffer from such an interference, there is a problem that channel estimation accuracy will deteriorate.

Some approaches to address such a problem are as follows, which can alleviate an interference that affects the single resource element. For example, as a first approach, there is a method which maps null signals, whose transmission power is zero, to resource elements that are adjacent to the single resource element. As a second approach, there is a method which alleviates an interference that arises at the single resource element by using orthogonal codes to cancel an interference on the single resource element, in other words, orthogonal codes for suppressing an interference that affects the single resource element to orthogonalize symbols transmitted over the resource elements that are adjacent to the single resource element as described in, for example, PTL 1 or the like. Further, as a third approach, there is a method which inserts an auxiliary signal, for the purpose of interference cancelation only, to any of resource elements that exist adjacent to the single resource element as described in, for example, NPL 1 or the like.

### CITATION LIST

### Patent Literature

[PTL 1] JP 2004-509562 T

### Non-Patent Literature

[NPL 1] J.-P. Javaudin, D. Lacroix, and A. Rouxel, “Pilot-aided channel estimation for OFDM/OQAM”, Vehicular Technology Conference, 2003, VTC 2003-Spring, Pages 1581-1585

### SUMMARY

### Technical Problem

In a case where interference suppression for a single resource element as described above is applied to a wireless communication system, it is desirable to arrange the interference suppression to be more flexibly performed depending on various requirements such as required Signal-to-Interference plus Noise Ratio (SINR) and channel estimation accuracy. However, for example, PTL 1, NPL 1, and the like make no consideration for allowing the interference suppression to be flexibly performed as described above.

An example object of the present invention is to allow interference suppression for a single resource element to be more flexibly performed in a communication scheme in which symbols are mapped to resource elements arranged in frequency direction and time direction.

### Solution to Problem

A first base station according to the present invention includes: a control information obtaining section configured to obtain control information related to a number of interfering resource elements that are subject to interference suppression for a target resource element; and a control information transmission section configured to transmit the control information to a terminal apparatus.

A first terminal apparatus according to the present invention includes: a control information reception section configured to receive, from a base station, control information related to a number of interfering resource elements that are subject to interference suppression for a target resource element; and a communication processing section configured to perform wireless communication with the base station, based on the control information.

A first method according to the present invention includes: obtaining control information related to a number of interfering resource elements that are subject to interference suppression for a target resource element; and transmitting the control information to a terminal apparatus.

A second method according to the present invention includes: receiving, from a base station, control information related to a number of interfering resource elements that are subject to interference suppression for a target resource element; and performing wireless communication with the base station, based on the control information.

A first program according to the present invention is a program for causing a processor to execute: obtaining control information related to a number of interfering resource elements that are subject to interference suppression for a target resource element; and transmitting the control information to a terminal apparatus.

A second program according to the present invention is a program for causing a processor to execute: receiving, from a base station, control information related to a number of interfering resource elements that are subject to interference suppression for a target resource element; and performing wireless communication with the base station, based on the control information.

A first recording medium according to the present invention is a non-transitory computer-readable recording medium having recorded thereon a program for causing a processor to execute: obtaining control information related to a number of interfering resource elements that are subject to interference suppression for a target resource element; and transmitting the control information to a terminal apparatus.

A second recording medium according to the present invention is a non-transitory computer-readable recording medium having recorded thereon a program for causing a processor to execute: receiving, from a base station, control information related to a number of interfering resource elements that are subject to interference suppression for a target resource element; and performing wireless communication with the base station, based on the control information.

A second base station according to the present invention includes: an orthogonal encoding section configured to encode a symbol of ACK/NACK information for uplink data received from a terminal apparatus by an orthogonal code for suppressing an interference that affects a target resource element; and a resource mapping section configured to map the symbol encoded by the orthogonal code to at least one interfering resource element causing an interference that affects the target resource element.

A second terminal apparatus according to the present invention includes: a resource demapping section configured to extract, from a signal received from a base station, a symbol of ACK/NACK information for uplink data mapped to an interfering resource element causing an interference that affects a target resource element; and an orthogonal decoding section configured to decode the symbol of the ACK/NACK information for the uplink data by an orthogonal code for suppressing an interference that affects the target resource element.

A third method according to the present invention includes: encoding a symbol of ACK/NACK information for uplink data received from a terminal apparatus by an orthogonal code for suppressing an interference that affects a target resource element; and mapping the symbol encoded by the orthogonal code to at least one interfering resource element causing an interference that affects the target resource element.

A fourth method according to the present invention includes: extracting, from a signal received from a base station, a symbol of ACK/NACK information for uplink data mapped to an interfering resource element causing an interference that affects a target resource element; and decoding the symbol of the ACK/NACK information for the uplink data by an orthogonal code for suppressing an interference that affects the target resource element.

A third program according to the present invention is a program for causing a processor to execute: encoding a symbol of ACK/NACK information for uplink data received from a terminal apparatus by an orthogonal code for suppressing an interference that affects a target resource element; and mapping the symbol encoded by the orthogonal code to at least one interfering resource element causing an interference that affects the target resource element.

A fourth program according to the present invention is a program for causing a processor to execute: extracting, from a signal received from a base station, a symbol of ACK/NACK information for uplink data mapped to an interfering resource element causing an interference that affects a target resource element; and decoding the symbol of the ACK/NACK information for the uplink data by an orthogonal code for suppressing an interference that affects the target resource element.

A third recording medium according to the present invention is a non-transitory computer-readable recording medium having recorded thereon a program for causing a processor to execute: encoding a symbol of ACK/NACK information for uplink data received from a terminal apparatus by an orthogonal code for suppressing an interference that affects a target resource element; and mapping the symbol encoded by the orthogonal code to at least one interfering resource element causing an interference that affects the target resource element.

A fourth recording medium according to the present invention is a non-transitory computer-readable recording medium having recorded thereon a program for causing a processor to execute: extracting, from a signal received from a base station, a symbol of ACK/NACK information for uplink data mapped to an interfering resource element causing an interference that affects a target resource element; and decoding the symbol of the ACK/NACK information for the uplink data by an orthogonal code for suppressing an interference that affects the target resource element.

### Advantageous Effects of Invention

According to the present invention, interference suppression for a single resource element can be more flexibly performed in a communication scheme in which symbols are mapped to resource elements arranged in frequency direction and time direction. Note that the present invention may exert other advantageous effects instead of the above advantageous effect or together with the above advantageous effect.

### BRIEF DESCRIPTION OF THE DRAWINGS

FIG. 1 is a diagram illustrating a configuration of a resource grid of FBMC/OQAM scheme;

FIG. 2 is a diagram illustrating a position of a target resource element (m₀, n₀) located within a resource block and not at an edge of the resource block;

FIG. 3 is a diagram illustrating a target resource element (m₀, n₀) located at an edge of a resource block in time direction;

FIG. 4 is a diagram illustrating a target resource element (m₀, n₀) located at an edge of a resource block in time direction;

FIG. 5 is a diagram illustrating a target resource element (m₀, n₀) located at an edge of a resource block in frequency direction;

FIG. 6 is a diagram illustrating a target resource element (m₀, n₀) located at an edge of a resource block in frequency direction;

FIG. 7 is a diagram illustrating target resource elements (resource elements to which a reference signal RS is mapped) located in a control channel region;

FIG. 8 is an explanatory diagram illustrating an example of a schematic configuration of a system 1 according to example embodiments of the present invention;

FIG. 9 is a block diagram illustrating an example of a schematic configuration of a base station according to a first example embodiment;

FIG. 10 is a block diagram illustrating an example of a schematic configuration of a terminal apparatus according to the first example embodiment;

FIG. 11 is a flowchart for describing an example of a schematic flow of process in the base station according to the first example embodiment;

FIG. 12 is a flowchart for describing an example of a schematic flow of process in the terminal apparatus according to the first example embodiment;

FIG. 13 is a block diagram illustrating an example of a schematic configuration of a base station 100 according to a second example embodiment;

FIG. 14 is a block diagram illustrating an example of a schematic configuration of a terminal apparatus 200 according to the second example embodiment;

FIG. 15 is a flowchart for describing an example of a schematic flow of process in the base station 100 according to the second example embodiment; FIG. 16 is a flowchart for describing an example of a schematic flow of process in the terminal apparatus 200 according to the second example embodiment;

FIG. 17 is a block diagram illustrating an example of a schematic configuration of a base station 100 according to a third example embodiment;

FIG. 18 is a block diagram illustrating an example of a schematic configuration of a terminal apparatus 200 according to the third example embodiment;

FIG. 19 is a block diagram illustrating an example of a schematic configuration of a base station 100 according to a fourth example embodiment; and

FIG. 20 is a block diagram illustrating an example of a schematic configuration of a terminal apparatus 200 according to the fourth example embodiment.

### DESCRIPTION OF THE EXAMPLE EMBODIMENTS

Example embodiments of the present invention will be described in detail below with reference to the accompanying drawings. Note that, in the present specification and drawings, elements to which similar descriptions are applicable are denoted by the same reference signs, whereby overlapping descriptions may be omitted.

Descriptions will be given in the following order.

1. Related Art

2. Overview of Example Embodiments of the Present Invention
2.1 Invention A
2.2. Invention B

3. Configuration of System

4. First Example Embodiment
4.1. Configuration of Base Station
4.2. Configuration of Terminal Apparatus
4.3. Technical Features

5. Second Example Embodiment
5.1. Configuration of Base Station
5.2. Configuration of Terminal Apparatus
5.3. Technical Features

6. Third Example Embodiment
6.1. Configuration of Base Station
6.2. Configuration of Terminal Apparatus
6.3. Technical Features

7. Fourth Example Embodiment
7.1. Configuration of Base Station
7.2. Configuration of Terminal Apparatus
7.3. Technical Features

### 1. Related Art

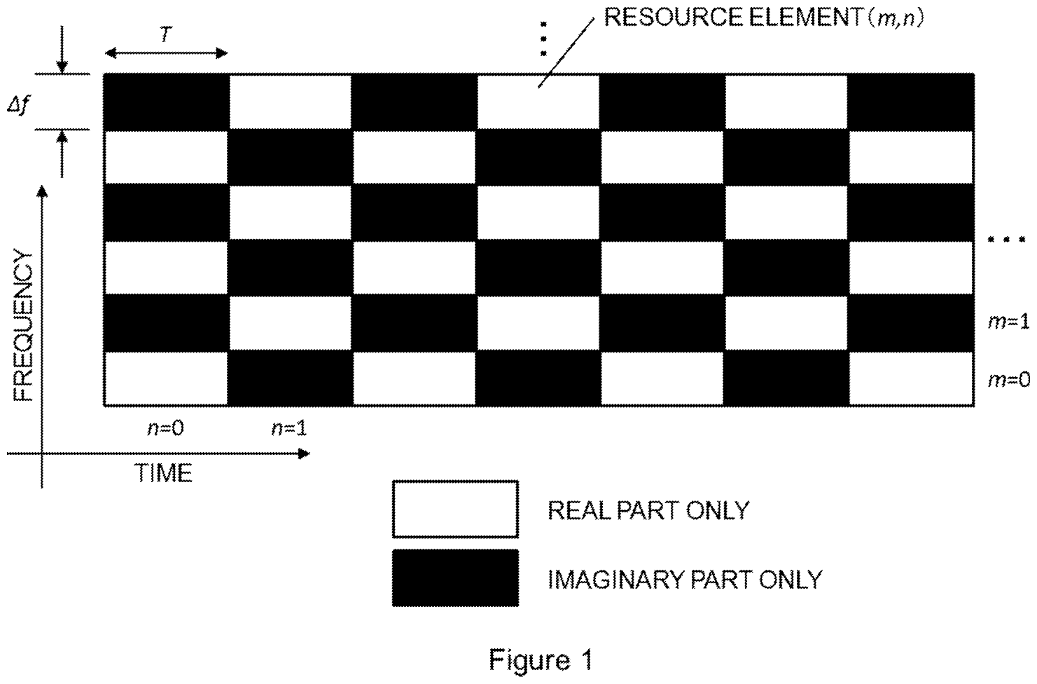

With reference to FIG. 1, a Filter Bank Multi-Carrier/Offset Quadrature Amplitude Modulation (FBMC/OQAM) scheme will be described as a technology related to example embodiments of the present invention.

The FBMC/OQAM scheme is a communication scheme which maps symbols to non-orthogonal resource elements arranged in frequency direction and time direction and is under consideration, as an alternative for OFDM scheme, in development of 5G or New RAT or New Radio (NR), which is a next-generation wireless communication standard, for the following reasons.

In 5G or New RAT or New Radio (NR), which is the next-generation wireless communication standard, it is under consideration to share consecutive frequency bands to efficiently accommodate various wireless communication services with different requirements such as communication speed, communication quality and communication delay. In order to satisfy such different communication requirements, there has been a proposal to use time-frequency resource units that are different per sub-band used by each wireless communication service. As an example, a short-duration time-frequency resource unit is used for a wireless communication service that requires small communication delay.

When different time-frequency resource unit is used for each sub-band, orthogonality between sub-bands is not guaranteed and, thus, an interference between sub-bands may occur. Thus, it has become an issue in terms of frequency utilization efficiency how each sub-band can be densely arranged while reducing the interference.

The conventional Orthogonal Frequency Division Multiplexing (OFDM) adopted in several wireless communication standards such as Long-Term Evolution (LTE), LTE-Advanced and Worldwide Interoperability for Microwave Access (Wimax) causes an interference to outside of the frequency band since a frequency response takes a form of a Sinc function. Hence, an additional filtering process or an insertion of a guard band would be needed to reduce the interference between sub-bands.

In contrast to the above-described OFDM scheme, the FBMC/OQAM scheme uses a filter whose frequency response and impulse response is localized. The localized frequency response allows for reducing the interference to outside of the frequency band compared to the OFDM scheme. The FBMC/OQAM scheme also has an advantage that, as its impulse response is localized, it can alleviate an effect of Inter-Symbol Interference (ISI) without inserting Cyclic Prefix (CP) that causes overhead.

FIG. 1 is a diagram illustrating a configuration of a resource grid of the FBMC/OQAM scheme. In the FBMC/OQAM scheme, as illustrated in FIG. 1, signals which consist of only real parts and signals which consist of only imaginary parts are arranged alternately in time and frequency directions, and they are filtered such that interferences between the real parts and between the imaginary parts become zero.

Note that the FBMC/OQAM scheme is sometimes denoted by a different name such as Orthogonal Frequency Division Multiplexing/Offset Quadrature Amplitude Modulation (OFDM/OQAM) or the like, however, the present specification uses the name of FBMC/OQAM for consistency.

In the FBMC/OQAM scheme, channel estimation accuracy will deteriorate because a reference signal suffers from an interference caused by resource elements that exist adjacent to a resource element to which the reference signal is mapped. This interference is an intrinsic one and exists at the moment of generating transmission signals regardless of channel fluctuation, presence or absence of noises and the like. This interference is referred to as an imaginary interference as it only contains imaginary parts.

In the FBMC/OQAM scheme, for signals other than the reference signal, the imaginary interference is ignorable since the signals will be finally demodulated in real domain. However, the reference signal is used for estimating fluctuation in amplitude and phase caused by channel on the complex plane and requires processing in complex domain and, thus, the imaginary interference is not ignorable. As a result, channel estimation accuracy deteriorates.

Thus, for example, interference suppression as described below needs to be performed on resource elements causing an interference that affects a target resource element (hereinafter referred to as interfering resource elements). Specifically, symbols generated using orthogonal codes for suppressing an interference that affects the target resource element are mapped to the interfering resource elements to suppress the interference that affects the target resource element. Moreover, symbols with zero transmission power (null) may be mapped to the interfering resource elements for interference suppression. Furthermore, a signal intended for interference cancelation may be mapped to at least one of the interfering resource elements for interference suppression.

Herein, the number of interfering resource elements (hereinafter denoted by N) varies depending on a position of the target resource element on a time-frequency plane.

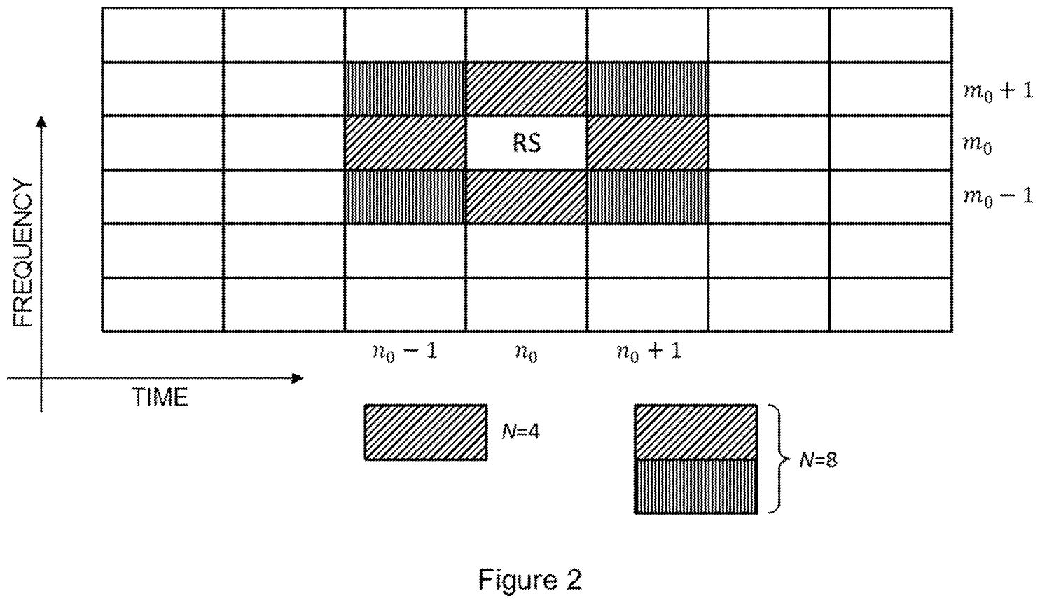

For example, FIG. 2 is a diagram illustrating a target resource element (m₀, n₀) located within a resource block and not at an edge of the resource block. In other words, in a case where the target resource element (m₀, n₀) is located as illustrated in FIG. 2, the number N of interfering resource elements is 4 or 8 as illustrated by hatched portions of FIG. 2. Specifically, in a case where N is 4, symbols generated using orthogonal codes for suppressing an interference that affects the target resource element (m₀, n₀) are mapped to interfering resource elements (m₀−1, n₀), (m₀+1, n₀), (m₀, n₁), (m₀, n₀+1).

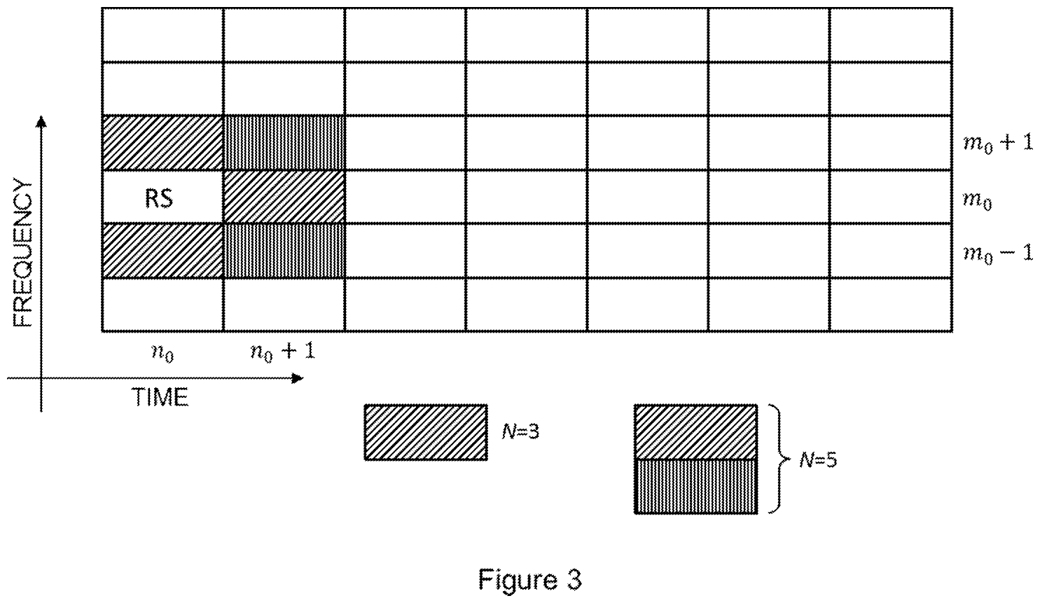

FIG. 3 is a diagram illustrating a target resource element (m₀, n₀) located at an edge of a resource block in time direction. In other words, in a case where the target resource element (m₀, n₀+1) is located as illustrated in FIG. 3, the number N of interfering resource elements is 3 or 5 as illustrated by hatched portions of FIG. 3. For example, in a case where N is 3, the symbols generated using orthogonal codes for suppressing the interference that affects the target resource element (m₀, n₀) are mapped to the interfering resource elements (m₀−1, n₀), (m₀+1, n₀), (m₀, n₀+1).

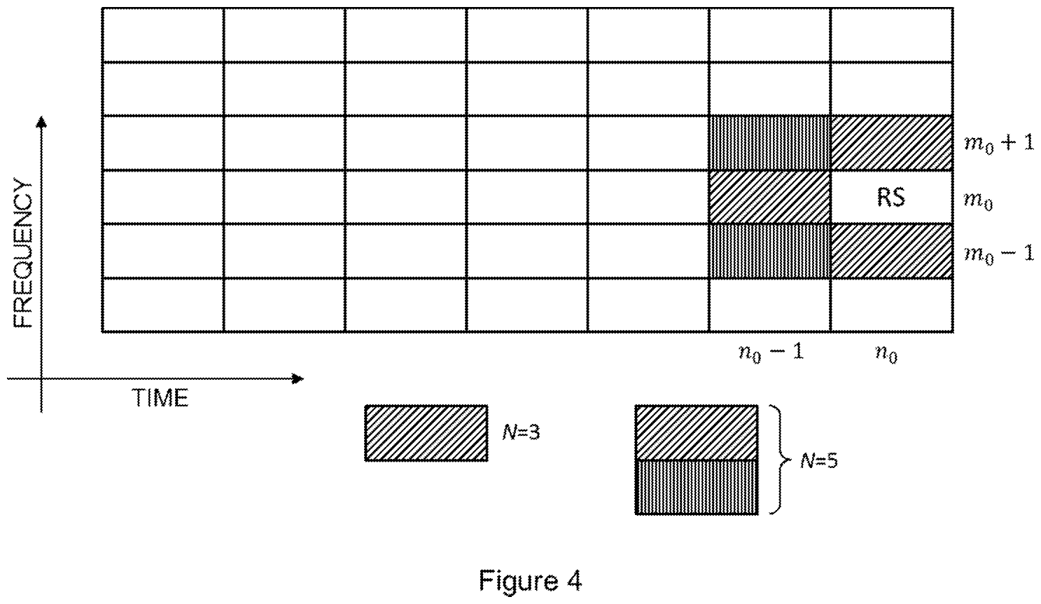

FIG. 4 is a diagram illustrating a target resource element (m₀, n₀) located at an edge of a resource block in time direction. In other words, in a case where the target resource element (m₀, n₀) is located as illustrated in FIG. 4, the number N of interfering resource elements is 3 or 5 as illustrated by hatched portions of FIG. 4. For example, in a case where N is 3, the symbols generated using orthogonal codes for suppressing the interference that affects the target resource element (m₀, n₀) are mapped to the interfering resource elements (m₀−1, n₀), (m₀+1, n₀), (m₀, n₀+1).

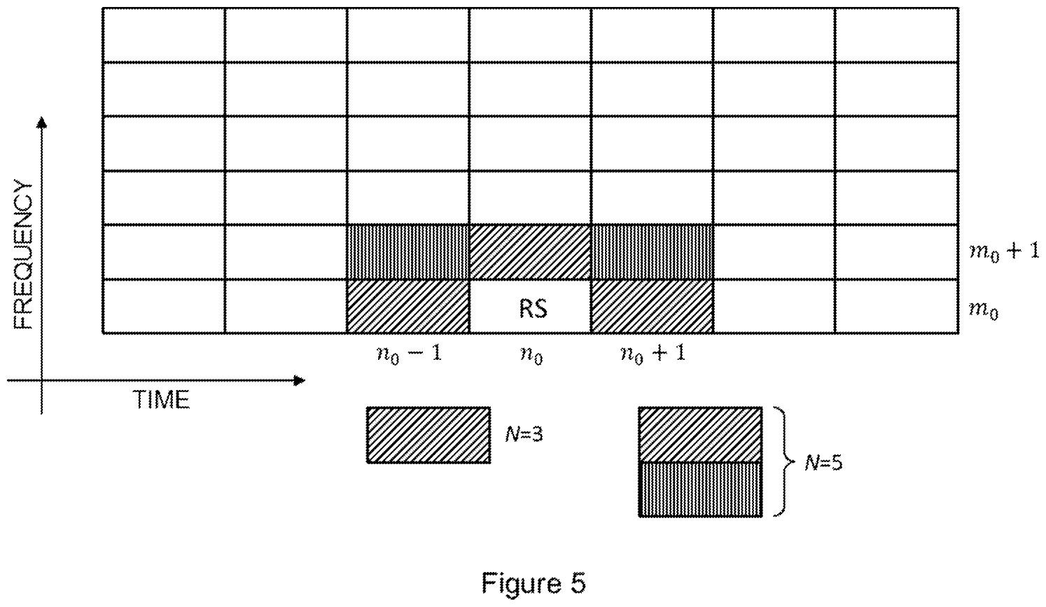

FIG. 5 is a diagram illustrating a target resource element (m₀, n₀) located at an edge of a resource block in frequency direction. In other words, in a case where the target resource element (m₀, n₀) is located as illustrated in FIG. 5, the number N of interfering resource elements is 3 or 5 as illustrated by hatched portions of FIG. 5. For example, in a case where N is 3, the symbols generated using orthogonal codes for suppressing the interference that affects the target resource element (m₀, n₀) are mapped to the interfering resource elements (m₀+1, n₀), (m₀, n₀−1), (m₀, n₀+1).

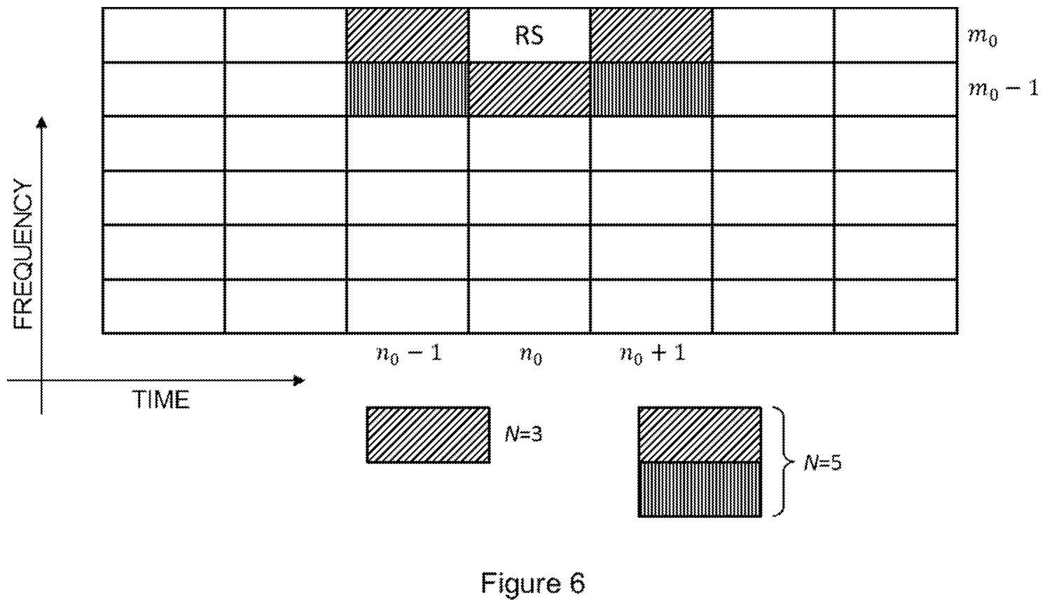

FIG. 6 is a diagram illustrating a target resource element (m₀, n₀) located at an edge of a resource block in frequency direction. In other words, in a case where the target resource element (m₀, n₀) is located as illustrated in FIG. 6, the number N of interfering resource elements is 3 or 5 as illustrated by hatched portions of FIG. 6. For example, in a case where N is 3, the symbols generated using orthogonal codes for suppressing the interference that affects the target resource element (m₀, n₀) are mapped to the interfering resource elements (m₀−1, n₀), (m₀, n₀−1), (m₀, n₀+1).

### 2. Overview of Example Embodiments of the Present Invention

An overview of example embodiments of the present invention will be described.

### <2.1. Invention A>

### (Technical Problems)

In a case where interference suppression for the target resource element is applied to a wireless communication system, it is desirable that interference suppression can be more flexibly performed depending on various requirements such as required SINR and required channel estimation accuracy. For example, in a case where the required SINR and channel estimation accuracy are high, the number of interfering resource elements is desirably increased in order to alleviate an interference that affects a target resource (reference signal) where possible. On the other hand, in a case where the required SINR and channel estimation accuracy are not high, it is desirable to reduce processing for interference suppression or to reduce the number of interfering resource elements in order to decrease wasteful use of resources.

### (Technical Features)

Thus, in the present example embodiments (first example embodiment and third example embodiment), for example, a base station (e.g., an eNB) obtains control information related to the number of interfering resource elements that are subject to interference suppression for a target resource element, and transmits the control information to a terminal apparatus (e.g., UE). Communication of such control information from the base station to the terminal apparatus will bring a common recognition of the number of interfering resource elements between the base station and the terminal apparatus. This allows interference suppression for the target resource element to be more flexibly performed.

Specifically, in a case where symbols orthogonally encoded by orthogonal codes for suppressing an interference that affects the target resource element are mapped to the interfering resource elements, a receiving side (the terminal apparatus during downlink transmission, the base station during uplink transmission) can easily identify the interfering resource elements, based on the number of interfering resource elements, to orthogonally decode the symbols mapped to the interfering resource elements.

In a case where null symbols are mapped to the interfering resource elements, the receiving side (the terminal apparatus during downlink transmission, the base station during uplink transmission) can easily recognize the number of ineffective resource elements without attempting to perform unnecessary decoding processing.

### <2.2. Invention B>

### (Technical Problems)

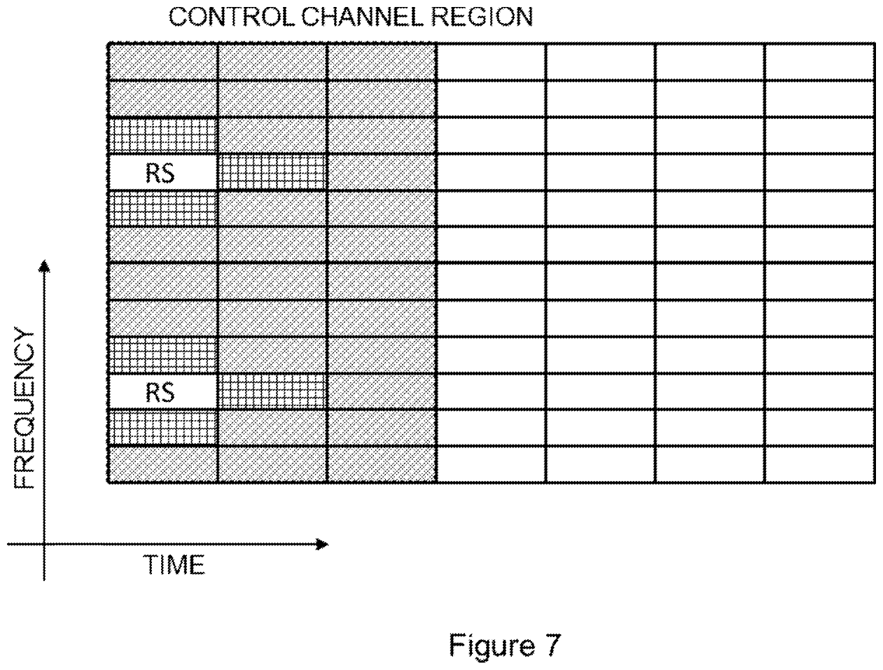

In a case where the target resource element is located in a control channel region where only control information is present, there is a problem as described below. FIG. 7 is a diagram illustrating target resource elements (the resource elements to which a reference signal RS is mapped) located in the control channel region. In downlink, to obtain control information (downlink control information or the like) destined for the terminal apparatus, the terminal apparatus needs to select a plurality of resource candidates in the control channel region to attempt decoding processing (blind decoding). Thus, in a case where the above-described resource candidates include an interfering resource element to which a symbol orthogonally encoded by an orthogonal code for suppressing the interference that affects the target resource element is mapped, processing loads needed for the attempt to perform the decoding processing will be increased by processing using the orthogonal code (orthogonal decoding).

### (Technical Features)

In the present example embodiments (second example embodiment and fourth example embodiment), for example, the base station (e.g., an eNB) encodes symbols of ACK/NACK information for uplink data received from the terminal apparatus by orthogonal codes for suppressing the interference that affects the target resource element, and maps the symbols encoded by the orthogonal codes to interfering resource elements causing an interference that affects the target resource element. Resource elements in which the ACK/NACK information for the uplink data is transmitted are uniquely determined based on indexes or the like of resource elements in which the uplink data has been transmitted. The interfering resource elements are thus uniquely determined. Consequently, the terminal apparatus can orthogonally decode the symbols mapped to the interfering resource elements without attempting to perform the orthogonal decoding on symbols mapped to resource elements other than the interfering resource elements.

### 3. Configuration of System

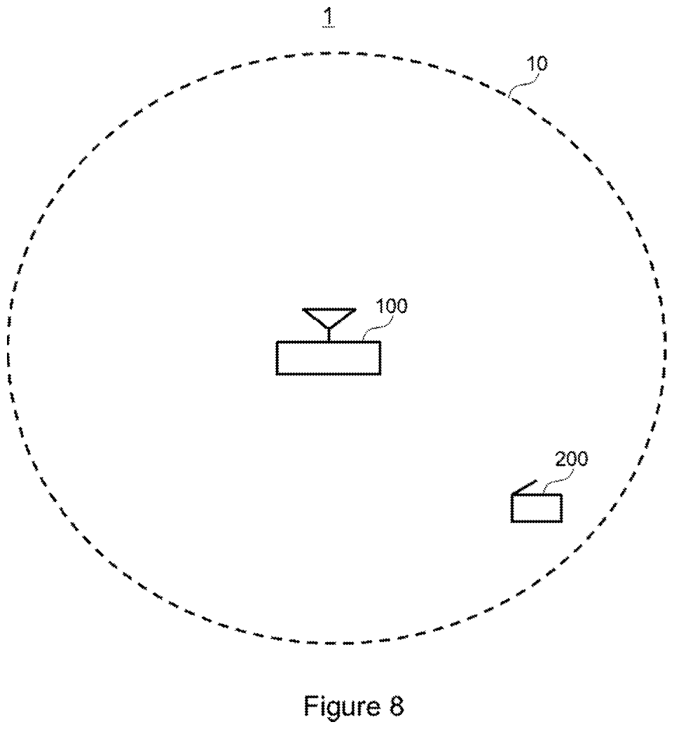

With reference to FIG. 8, an example of a configuration of a system 1 according to example embodiments will be described. FIG. 8 is an explanatory diagram illustrating an example of a schematic configuration of the system 1 according to the example embodiments of the present invention. With reference to FIG. 8, the system 1 includes a base station 100 and a terminal apparatus 200.

For example, the system 1 is a system that conforms to a standard of Third Generation Partnership Project (3GPP). More specifically, the system 1 may be a system that conforms to LTE/LTE-Advanced and/or System Architecture Evolution (SAE). Alternatively, the system 1 may be a system that conforms to fifth generation (5G) standard. The system 1 is, of course, not limited to such examples.

(1) Base Station 100

The base station 100 is a node of a Radio Access Network (RAN) and performs wireless communication with terminal apparatuses (e.g., the terminal apparatus 200) located within a coverage area 10. For example, the base station 100 is an eNB.

The base station 100 is a node which performs wireless communication with the terminal apparatus, in other words, a Radio Access Network (RAN) node. For example, the base station 100 may be an evolved Node B (eNB) or a generation Node B (gNB) in 5G. The base station 100 may include a plurality of units (or a plurality of nodes). The plurality of units (or the plurality of nodes) may include a first unit (or a first node) configured to perform higher protocol layer processing and a second unit (or a second node) configured to perform lower protocol layer processing. As an example, the first unit may be referred to as a center/central unit (CU), and the second unit may be referred to as a distributed unit (DU) or an access unit (AU). As another example, the first unit may be referred to as a digital unit (DU), and the second unit may be referred to as a radio unit (RU) or a remote unit (RU). The digital unit (DU) may be a base band unit (BBU), and the RU may be a remote radio head (RRH) or a remote radio unit (RRU). The terms for the first unit (or the first node) and the second unit (or the second node) are, of course, not limited to these examples. Alternatively, the base station 100 may be a single unit (or a single node). In this case, the base station 100 may be one of the plurality of units (e.g., one of the first unit and the second unit), or may be connected to another of the plurality of units (e.g., the other of the first unit and the second unit).

(2) Terminal Apparatus 200

The terminal apparatus 200 performs wireless communication with the base station 100. For example, the terminal apparatus 200 performs wireless communication with the base station 100 in a case of being located in the coverage area 10 of the base station 100. For example, the terminal apparatus 200 is a user equipment (UE) and receives signals from the base station 100 in downlink and transmits signals to the base station 100 in uplink.

### 4. First Example Embodiment

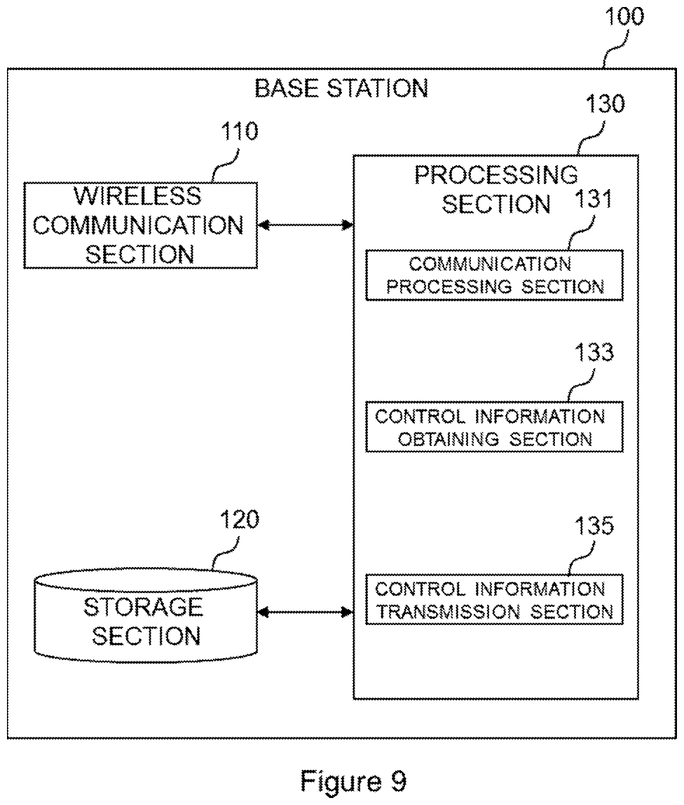

Next, a description will be given of a first example embodiment of the present invention with reference to FIG. 9 to FIG. 12.

### <4.1. Configuration of Base Station>

With reference to FIG. 9, a description will be given of an example of a configuration of the base station 100 according to the first example embodiment. FIG. 9 is a block diagram illustrating an example of a schematic configuration of the base station 100 according to the first example embodiment. With reference to FIG. 9, the base station 100 includes a wireless communication section 110, a storage section 120, and a processing section 130.

(1) Wireless Communication Section 110

The wireless communication section 110 wirelessly transmits and/or receives a signal, for example, in accordance with the FBMC/OQAM scheme. For example, the wireless communication section 110 receives a signal from a terminal apparatus and transmits a signal to the terminal apparatus.

(2) Storage Section 120

The storage section 120 temporarily or permanently stores programs and parameters for operations of the base station 100 as well as various data.

(3) Processing Section 130

The processing section 130 provides various functions of the base station 100. The processing section 130 includes a communication processing section 131, a control information obtaining section 133, and a control information transmission section 135. Note that the processing section 130 may further include other constituent elements than these constituent elements. In other words, the processing section 130 may perform operations other than the operations of these constituent elements. Concrete operations of the communication processing section 131, the control information obtaining section 133, and the control information transmission section 135 will be described later in detail. For example, the processing section 130 (communication processing section 131 ) communicates with the terminal apparatus (e.g., the terminal apparatus 200 ) via the wireless communication section 110.

(4) Implementation Example

The wireless communication section 110 may be implemented with an antenna, a radio frequency (RF) circuit, and the like, and the antenna may be a directional antenna. The storage section 120 may be implemented with a memory (e.g., a nonvolatile memory and/or a volatile memory), a hard disk and/or the like. The processing section 130 may be implemented with a baseband (BB) processor, another processor and/or the like. The communication processing section 131, the control information obtaining section 133, and the control information transmission section 135 may be implemented with the same processor or may be implemented with respective different processors. The memory (storage section 120) may be included in such a processor (chip).

The base station 100 may include a memory configured to store a program and one or more processors that can execute the program, and the one or more processors may perform operations of the processing section 130 (operations of the communication processing section 131, the control information obtaining section 133, and/or the control information transmission section 135). The program may be a program for causing the one or more processors to execute the operations of the processing section 130 (the operations of the communication processing section 131, the control information obtaining section 133, and/or the control information transmission section 135).

### <4.2. Configuration of Terminal Apparatus>

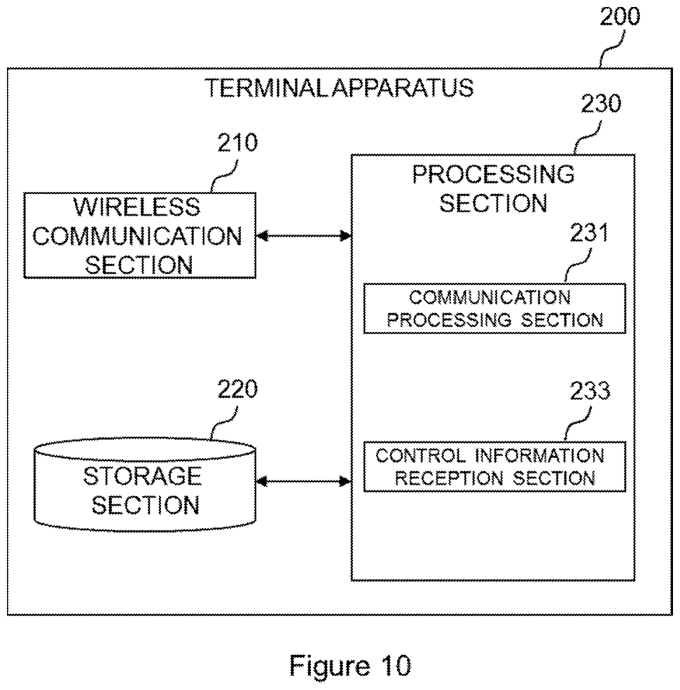

With reference to FIG. 10, an example of a configuration of the terminal apparatus 200 according to the first example embodiment will be described. FIG. 10 is a block diagram illustrating an example of a schematic configuration of the terminal apparatus 200 according to the first example embodiment. With reference to FIG. 10, the terminal apparatus 200 includes a wireless communication section 210, a storage section 220, and a processing section 230.

(1) Wireless Communication Section 210

The wireless communication section 210 wirelessly transmits and/or receives a signal, for example, in accordance with the FBMC/OQAM scheme. For example, the wireless communication section 210 receives a signal from the base station 100 and transmits a signal to the base station 100.

(2) Storage Section 220

The storage section 220 temporarily or permanently stores programs and parameters for operations of the terminal apparatus 200 as well as various data.

(3) Processing Section 230

The processing section 230 provides various functions of the terminal apparatus 200. The processing section 230 includes a communication processing section 231 and a control information reception section 233. Note that the processing section 230 may further include other constituent elements than these constituent elements. In other words, the processing section 230 may perform operations other than the operations of these constituent elements. Concrete operations of the communication processing section 231 and the control information reception section 233 will be described later in detail.

For example, the processing section 230 (communication processing section 231) communicates with the base station (e.g., the base station 100) via the wireless communication section 210.

(4) Implementation Example

The wireless communication section 210 may be implemented with an antenna, a radio frequency (RF) circuit, and the like. The storage section 220 may be implemented with a memory (e.g., a nonvolatile memory and/or a volatile memory), a hard disk and/or the like. The processing section 230 may be implemented with a baseband (BB) processor, another processor and/or the like. The communication processing section 231, the control information reception section 233, and a control information storage section 235 may be implemented with the same processor or may be implemented with respective different processors. The memory (storage section 220) may be included in such a processor (chip).

The terminal apparatus 200 may include a memory configured to store a program and one or more processors that can execute the program, and the one or more processors may perform operations of the processing section 230 (operations of the communication processing section 231 and/or the control information reception section 233). The program may be a program for causing the one or more processors to execute the operations of the processing section 230 (the operations of the communication processing section 231 and/or the control information reception section 233).

### <4.3. Technical Features>

Next, technical features of the first example embodiment will be described.

The base station 100 (control information obtaining section 133) obtains control information related to the number of interfering resource elements that are subject to interference suppression for the target resource element. The base station 100 (control information transmission section 135) transmits the obtained control information to the terminal apparatus 200.

(1) Target Resource Element

The target resource element is, for example, a resource element located at any frequency and time position in a radio resource (e.g., a resource block) allocated to the terminal apparatus 200. Specifically, the target resource element is a resource element to which a reference signal is mapped. Note that a reference signal may, of course, be mapped to another resource element.

For example, in the example illustrated in FIG. 2, the target resource element (m₀, n₀) is located within a resource block and not at an edge of the resource block. In the examples illustrated in FIG. 3 and FIG. 4, the target resource element (m₀, n₀) is located at an edge of a resource block in time direction. In the examples illustrated in FIG. 5 and FIG. 6, the target resource element (m₀, n₀) is located at an edge of a resource block in frequency direction.

(2) Interference Suppression

The interference suppression refers to suppression of an interference that affects the target resource element. Specifically, the interference suppression is to map, to the interfering resource elements, symbols generated using orthogonal codes for suppressing the interference that affects the target resource element. Moreover, the interference suppression may be to map null symbols with zero transmission power to the interfering resource elements. Furthermore, the interference suppression may be to map, to at least one of the interfering resource elements, a signal (hereinafter referred to as an interference canceling signal) for canceling the interference that affects the target resource element.

(3) Interfering Resource Elements

The interfering resource elements are resource elements to which the interference suppression for the target resource element is applied. In other words, the interfering resource elements are resource elements located within a range for interference suppression for the target resource element and are, for example, resource elements located around the target resource element. For example, as illustrated in FIG. 2 to FIG. 6, the interfering resource elements may include resource elements neighboring the target resource element in time direction and resource elements neighboring the target resource element in frequency direction.

The interfering resource elements may further include resource elements as described in the following example. As an example, as illustrated in FIG. 2, FIG. 5, and FIG. 6, the interfering resource elements may further include resource elements each at a position one resource element shifted in time direction from the corresponding resource element neighboring the target resource element in frequency direction. As another example, as illustrated in FIG. 2, FIG. 3, and FIG. 4, the interfering resource elements may further include resource elements each at a position one resource element shifted in frequency direction from the corresponding resource element neighboring the target resource element in time direction.

For example, as illustrated in FIG. 2, in a case where the target resource element (m₀, n₀) is located within a radio resource allocated to the terminal apparatus 200 and not at an edge of the radio resource, the number N of interfering resource elements is 4 or 8. n a case where N is 4, the interfering resource elements include two resource elements (m₀, n₀−1), (m₀, n₀+1) neighboring the target resource element (m₀, n₀) in time direction and two resource elements (m₀−1, n₀), (m₀+1, n₀) neighboring the target resource element (m₀, n₀) in frequency direction. Moreover, in a case where N is 8, the interfering resource elements include four resource elements (m₀−1, n₀−1), (m₀−1, n₀+1), (m₀−1,n₀−1), (m₀ +1,n₀+1) each at a position one resource element shifted in time direction from a corresponding one of the resource elements (m₀−1, n₀), (m₀+1, n₀) neighboring the target resource element (m₀−1, n₀) in frequency direction. In other words, the interfering resource elements may include four resource elements each at a position one resource element shifted in frequency direction from the corresponding one of the resource elements (m₀, nₒ−1), (m₀, n₀+1) neighboring the target resource element (m₀, n₀) in time direction.

In contrast, for example, as illustrated in FIG. 3 to FIG. 6, in a case where the target resource element (m₀, n₀) is located at an edge of a radio resource allocated to the terminal apparatus 200, the number N of interfering resource elements is 3 or 5. For example, in a case where N is 3 in the example in FIG. 3, the interfering resource elements include one resource element (m₀, n₀+1) neighboring the target resource element (m₀, n₀) in time direction and two resource elements (m₀−1, n₀), (m₀+1, n₀) neighboring the target resource element (m₀, n₀) in frequency direction. Moreover, in a case where N is 5 in the example in FIG. 3, the interfering resource elements may include two resource elements (m₀−1, n₀+1), (m₀+1, n₀+1) at positions one resource element shifted in frequency direction from the resource element (m₀, n₀+1) neighboring the target resource element (m₀, n₀) in time direction.

Note that the radio resource allocated to the terminal apparatus 200 may be two or more resource blocks that are consecutive in at least one of frequency direction and time direction.

For example, in a case where the target resource element is located within an aggregation of two or more resource blocks and not at an edge of the aggregation (in frequency direction or time direction), the number N of interfering resource elements may be 4 or 8. For example, in a case where the target resource element is located at an edge (in frequency direction or time direction) of an aggregation of two or more resource blocks, the number N of interfering resource elements may be 3 or 5.

The interfering resource elements are not limited to the above-described examples illustrated in FIG. 2 to FIG. 6 and they may be any resource elements to which the interference suppression for the target resource element is applied. In other words, they may be any resource elements located within a range for the interference suppression. For example, the interfering resource elements may be located around the target resource element and, for example, the interfering resource elements may include resource elements two or three resource elements distant from the target resource element in frequency direction or time direction.

(4) Control Information

The control information is related to the number N of interfering resource elements and is, specifically, control information related both to the number N of interfering resource elements and a modulation and coding scheme. The number N of interfering resource elements is a number determined depending on a power ratio between a reference signal and a data symbol and/or the modulation and coding scheme. More specifically, the control information is an index identifying both the number N of interfering resource elements and the modulation and coding scheme, for example, a Modulation and Coding Scheme (MCS) index. Note that the control information is not limited to the MCS index but may be an index for identifying one of the number N of interfering resource elements and the modulation and coding scheme.

(4-1) MCS

Herein, a relationship between the MCS and the number N of interfering resource elements will be described. In general, the required Signal-to-Interference plus Noise Ratio (SINR) and channel estimation accuracy increase when a modulation order or a coding rate increases. On the other hand, a larger number N of interfering resource elements leads to reduction in the number of resource elements causing an interference, allowing the imaginary interference to be alleviated. This improves an average channel estimation accuracy. Therefore, a certain level of correlation is present between the MCS and N, and it is considered that the minimum N needed to achieve required Block Error Rate (BLER) depends on MCS.

(4-2) Power Ratio between Reference Signal and Data Symbol

A relationship between the number N of interfering resource elements and the power ratio between a reference signal and a data symbol will be described. In a case where transmission power for the reference signal is higher than transmission power for the data symbol, contribution to channel estimation error of imaginary interference resulting from the data symbol is relatively small and, thus, N can be set to be smaller.

(4-3) Technique for Determining Number of Interfering Resource Elements and Method to Communicate It

Therefore, the value of N can be uniquely determined by taking into account at least one of the MCS index and the power ratio between a reference signal and a data symbol. Specifically, as an example, a correspondence table like Table 1 may be used.

TABLE 1

| | | | Number of Coded REs N | |
|---|---|---|---|---|
| MCS | Modulation | Coding | RS/Data | RS/Data |
| Index | Scheme | Rate | Power Ratio = Low | Power Ratio = High |
| 0 | QPSK | 1/4 | 4 (3 for edge RE) | 0 |
| 1 | QPSK | 1/3 | 4 (3 for edge RE) | 0 |
| 2 | 16QAM | 1/3 | 4 (3 for edge RE) | 4 (3 for edge RE) |
| 3 | 16QAM | 1/2 | 8 (5 for edge RE) | 4 (3 for edge RE) |
| 4 | 64QAM | 1/2 | 8 (5 for edge RE) | 4 (3 for edge RE) |
| 5 | 64QAM | 2/3 | 8 (5 for edge RE) | 8 (5 for edge RE) |
| 6 | 256QAM | 2/3 | 8 (5 for edge RE) | 8 (5 for edge RE) |
| 7 | 256QAM | 3/4 | 8 (5 for edge RE) | 8 (5 for edge RE) |

Herein, consider a case where information shown in Table 1 is shared between the base station 100 and the terminal apparatus 200 and that information related to the power ratio between a reference signal and a data symbol is communicated in advance from the base station 100 to the terminal apparatus 200 by using, for example, one or both of an RRC message and system information. In such a case, the base station 100 can also implicitly communicate the number N of interfering resource elements to the terminal apparatus 200 by transmitting an MCS index to the terminal apparatus 200. To put it simply, such communication of MCS index is preferable in that the communication eliminates a need to add control bits for communicating the number N of interfering resource elements, thus avoiding an increase in overhead.

Note that, in a case where information transmitted in a control channel region is mapped to an interfering resource element, the MCS index is not communicated to the terminal apparatus 200 whenever such information is transmitted and, thus, it is difficult to implicitly communicate the number N of interfering resource elements by using the MCS index. In such a case, for example, the number N of interfering resource elements may be included, as a semi-static value, in broadcast information which is broadcasted to a plurality of terminal apparatuses by the base station 100.

(4-4) Obtainment of Control Information

The control information obtaining section 133, for example, accesses the storage section 120 to obtain the control information related to the number N of interfering resource elements. The control information stored in the storage section 120 is generated by, for example, the base station 100. Note that the control information stored in the storage section 120 is not limited to the case of being generated by the base station 100 and may, for example, be received from outside via the wireless communication section 110. The control information obtaining section 133 may, for example, obtain (receive) the control information directly from outside via the wireless communication section 110 without accessing the storage section 120.

(4-5) Transmission of Control Information

The control information related to the number N of interfering resource elements is transmitted to the terminal apparatus 200. Specifically, the control information related to the number N of interfering resource elements is included specifically in the following information and transmitted to the terminal apparatus 200.

(Downlink Control Information)

The control information related to the number N of interfering resource elements is included in downlink control information. In other words, the control information related to the number N of interfering resource elements is included in downlink control information and transmitted. Specifically, the base station 100 (control information obtaining section 133) obtains the downlink control information including resource allocation information and the control information for the terminal apparatus 200. The base station 100 (control information transmission section 135) then transmits the downlink control information to the terminal apparatus 200. This enables, for example, the terminal apparatus 200 to quickly obtain the number N of interfering resource elements. Thus, even when the number N of interfering resource elements is dynamically changed, the terminal apparatus 200 can adapt accordingly to such a change in the number N of interfering resource elements.

(MAC Control Element)

The control information related to the number N of interfering resource elements may be included in a MAC control element. In other words, the control information related to the number N of interfering resource elements may be included in a MAC control element and transmitted. Specifically, the base station 100 (control information obtaining section 133) obtains the MAC control element including the control information. The base station 100 (control information transmission section 135) then transmits the MAC control element to the terminal apparatus 200. This enables, for example, the terminal apparatus 200 to quickly obtain the number N of interfering resource elements. Thus, even when the number N of interfering resource elements is dynamically changed, the terminal apparatus 200 can adapt accordingly to such a change in the number N of interfering resource elements.

(RRC Message)

The control information related to the number N of interfering resource elements may be included in an RRC message. In other words, the control information related to the number N of interfering resource elements may be included in an RRC message and transmitted. Specifically, the base station 100 (control information obtaining section 133) obtains the RRC message including the control information. The base station 100 (control information transmission section 135) transmits the RRC message to the terminal apparatus 200. The RRC message is, for example, system information including the control information. The RRC message may be a signaling message dedicated to a terminal apparatus and including the control information.

(Change in Number of Interfering Resource Elements)

The base station 100 may include a changed number N of interfering resource elements in the above-described control information and transmit it to the terminal apparatus 200 triggered by a change in the number of interfering resource elements. With a change in the number of interfering resource elements, the base station 100 may orthogonally encode symbols by using orthogonal codes for interference suppression corresponding to the changed number N of interfering resource elements.

(5) Operation of Terminal Apparatus

The terminal apparatus 200 (control information reception section 233) obtains the control information related to the number N of interfering resource elements. The terminal apparatus 200 (communication processing section 231 ) performs wireless communication with the base station 100, based on the control information. The wireless communication may be reception of a downlink signal from the base station 100 or transmission of an uplink signal to the base station 100.

For example, in a case where symbols generated using orthogonal codes for suppressing the interference that affects the target resource element are mapped to interfering resource elements, the control information is used as follows. Specifically, in downlink, the terminal apparatus 200 (communication processing section 231) uses orthogonal codes for interference suppression, corresponding to the number of interfering resource elements, to orthogonally decode the symbols mapped to the interfering resource elements. On the other hand, in uplink, the terminal apparatus 200 (communication processing section 231) uses the orthogonal code for interference suppression, corresponding to the number of interfering resource elements, to orthogonally encode symbols. The terminal apparatus 200 then maps the orthogonally encoded symbols to the interfering resource elements and transmits them to the base station 100.

In a case where null symbols with zero transmission power are mapped to the interfering resource elements for interference suppression, ineffective resource elements are recognized by referring to the control information during downlink transmission, whereas the null symbols are mapped to the interfering resource elements by referring to the control information during uplink transmission.

Furthermore, in a case where the interference canceling signal is mapped to at least one of the interfering resource elements for interference suppression, then during uplink transmission, the interference canceling signal is generated by referring to the control information, depending on the number of interfering resource elements and on the values of the symbols mapped to the interfering resource elements. The generated interference canceling signal is mapped to an interfering resource element other than resource elements to which the symbols are mapped.

(6) Flow of Process

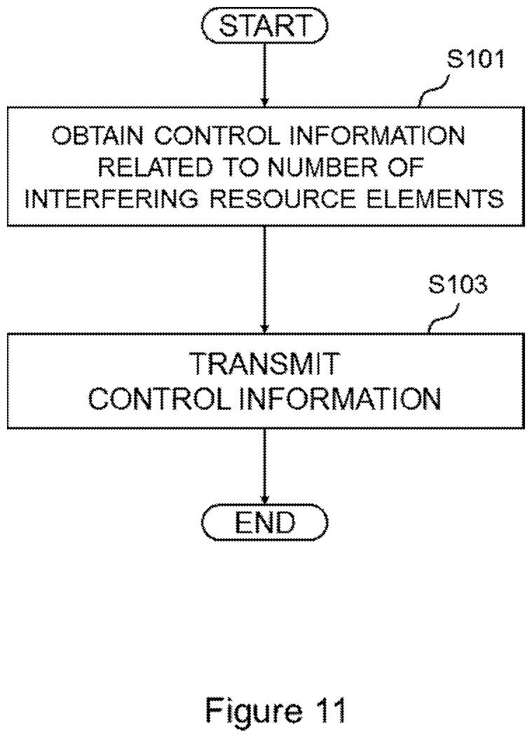

FIG. 11 is a flowchart for describing an example of a schematic flow of process in the base station 100 according to the first example embodiment.

The base station 100 (control information obtaining section 133) obtains the control information related to the number of interfering resource elements that are subject to interference suppression for the target resource element (S101). The base station 100 (control information transmission section 135) then transmits the obtained control information to the terminal apparatus 200 (S102).

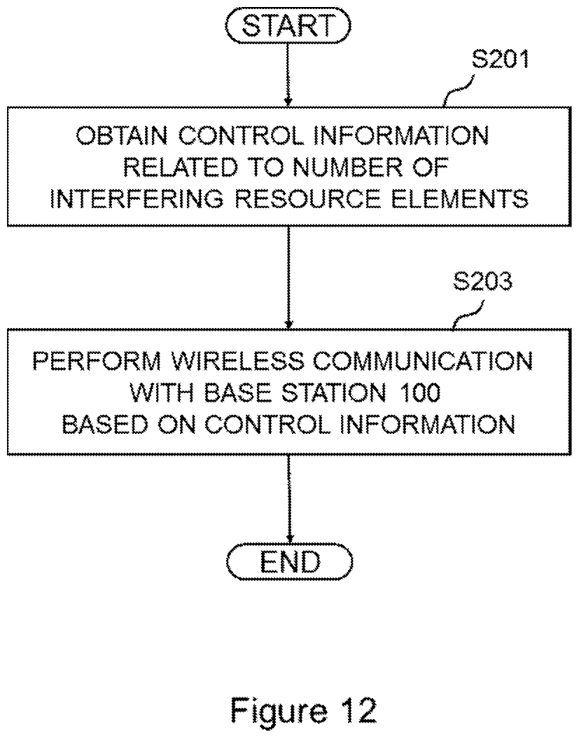

FIG. 12 is a flowchart for describing an example of a schematic flow of process in the terminal apparatus 200 according to the first example embodiment.

The terminal apparatus 200 (control information reception section 233) obtains the control information related to the number N of interfering resource elements (S201). The terminal apparatus 200 (communication processing section 231) then performs wireless communication with the base station 100 based on the control information (S202).

### (7) Summary

As described above, communication of the control information from the base station 100 to the terminal apparatus 200 brings a common recognition of the number of interfering resource elements between the base station 100 and the terminal apparatus 200. This makes it possible to perform interference suppression for the target resource element more flexibly, for example, depending on required SINR and channel estimation accuracy. Specifically, in a case where the symbols orthogonally encoded by orthogonal codes for suppressing an interference that affects the target resource element are mapped to the interfering resource elements, the receiving side (the terminal apparatus 200 during downlink transmission, the base station 100 during uplink transmission) can easily identify the interfering resource elements to orthogonally decode the symbols mapped to the interfering resource elements. In a case where null symbols are mapped to the interfering resource elements, the receiving side (the terminal apparatus 200 during downlink transmission, the base station 100 during uplink transmission) can recognize the number of ineffective resource elements. Furthermore, in a case where the interference canceling signal is mapped to at least one of the interfering resource elements, the number of interfering resource elements is used as a factor to determine an average of transmission power to be distributed to the interference canceling signal during uplink transmission, thereby it will be possible to prevent transmission power from being distributed excessively to the interference canceling signal.

### 5. Second Example Embodiment

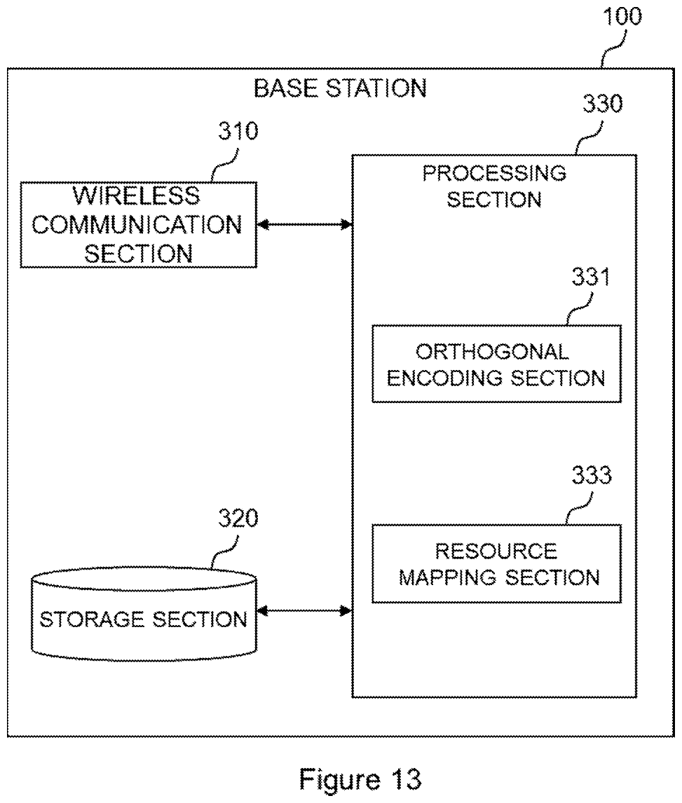

Next, a description will be given of a second example embodiment of the present invention with reference to FIG. 13 to FIG. 16.

### <5.1. Configuration of Base Station>

With reference to FIG. 13, a description will be given of an example of a configuration of a base station 100 according to the second example embodiment. FIG. 13 is a block diagram illustrating an example of a schematic configuration of the base station 100 according to the second example embodiment. With reference to FIG. 13, the base station 100 includes a wireless communication section 310, a storage section 320, and a processing section 330.

(1) Wireless Communication Section 310

The wireless communication section 310 wirelessly transmits and/or receives a signal, for example, in accordance with the FBMC/OQAM scheme. For example, the wireless communication section 310 receives a signal from a terminal apparatus and transmits a signal to the terminal apparatus.

(2) Storage Section 320

The storage section 320 temporarily or permanently stores programs and parameters for operations of the base station 100 as well as various data.

(3) Processing Section 330

The processing section 330 provides various functions of the base station 100. The processing section 330 includes an orthogonal encoding section 331 and a resource mapping section 333. Note that the processing section 330 may further include other constituent elements than these constituent elements. In other words, the processing section 330 may perform operations other than the operations of these constituent elements. Concrete operations of the orthogonal encoding section 331 and the resource mapping section 333 will be described later in detail. For example, the processing section 330 communicates with the terminal apparatus (e.g., a terminal apparatus 200) via the wireless communication section 110.

(4) Implementation Example

The wireless communication section 310 may be implemented with an antenna, a radio frequency (RF) circuit, and the like, and the antenna may be a directional antenna. The storage section 320 may be implemented with a memory (e.g., a nonvolatile memory and/or a volatile memory), a hard disk and/or the like. The processing section 330 may be implemented with a baseband (BB) processor, another processor and/or the like. The orthogonal encoding section 331 and the resource mapping section 333 may be implemented with the same processor or may be implemented with respective different processors. The memory (storage section 320) may be included in such a processor (chip).

The base station 100 may include a memory configured to store a program and one or more processors that can execute the program, and the one or more processors may perform operations of the processing section 330 (operations of the orthogonal encoding section 331 and/or the resource mapping section 333). The program may be a program for causing the one or more processors to execute the operations of the processing section 130 (the operations of the orthogonal encoding section 331 and/or the resource mapping section 333 ).

### <5.2. Configuration of Terminal Apparatus>

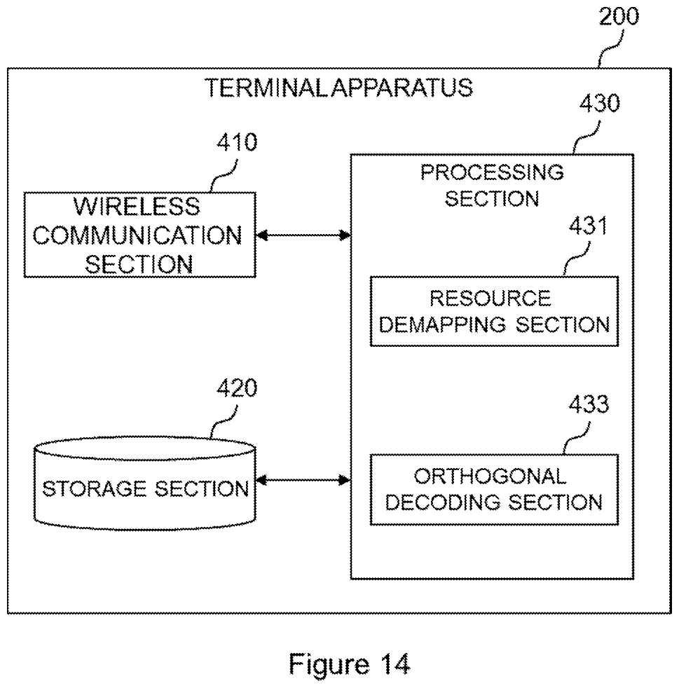

With reference to FIG. 14, an example of a configuration of the terminal apparatus 200 according to the second example embodiment will be described. FIG. 14 is a block diagram illustrating an example of a schematic configuration of the terminal apparatus 200 according to the second example embodiment. With reference to FIG. 14, the terminal apparatus 200 includes a wireless communication section 410, a storage section 420, and a processing section 430.

(1) Wireless Communication Section 410

The wireless communication section 410 wirelessly transmits and/or receives a signal, for example, in accordance with the FBMC/OQAM scheme. For example, the wireless communication section 410 receives a signal from a base station and transmits a signal to the base station.

(2) Storage Section 420

The storage section 420 temporarily or permanently stores programs and parameters for operations of the terminal apparatus 200 as well as various data.

(3) Processing Section 430

The processing section 430 provides various functions of the terminal apparatus 200. The processing section 430 includes a resource demapping section 431 and an orthogonal decoding section 433. Note that the processing section 430 may further include other constituent elements than these constituent elements. In other words, the processing section 430 may perform operations other than the operations of these constituent elements. Concrete operations of the resource demapping section 431 and the orthogonal decoding section 433 will be described later in detail.

For example, the processing section 430 communicates with the base station (e.g., the base station 100) via the wireless communication section 410.

(4) Implementation Example

The wireless communication section 410 may be implemented with an antenna, a radio frequency (RF) circuit, and the like. The storage section 420 may be implemented with a memory (e.g., a nonvolatile memory and/or a volatile memory), a hard disk and/or the like. The processing section 430 may be implemented with a baseband (BB) processor, another processor and/or the like. The resource demapping section 431 and the orthogonal decoding section 433 may be implemented with the same processor or may be implemented with respective different processors. The memory (storage section 420 ) may be included in such a processor (chip).

The terminal apparatus 200 may include a memory configured to store a program and one or more processors that can execute the program, and the one or more processors may perform operations of the processing section 430 (operations of the resource demapping section 431 and/or the orthogonal decoding section 433 ). The program may be a program for causing the one or more processors to execute the operations of the processing section 230 (the operations of the resource demapping section 431 and/or the orthogonal decoding section 433).

### <5.3. Technical Features>

Next, technical features of the second example embodiment will be described.

The base station 100 (orthogonal encoding section 331 ) encodes symbols of ACK/NACK information for uplink data received from the terminal apparatus 200, by orthogonal codes for suppressing an interference that affects a target resource element. The base station 100 (resource mapping section 333) then maps the symbols encoded by the orthogonal codes to interfering resource elements causing an interference that affects the target resource element.

(1) Target Resource Element

The target resource element is, for example, a resource element located at any frequency and time position in a radio resource (e.g., a resource block) allocated to the terminal apparatus 200. Specifically, the target resource element is a resource element to which a reference signal is mapped. For example, in an example illustrated in FIG. 7, two reference signals RS are mapped to the target resource elements. Note that a reference signal may, of course, be mapped to other resource elements.

For example, as illustrated in FIG. 7, the target resource elements are located within a control channel region. Specifically, the target resource elements are located within the control channel region at an edge of the control channel region in time direction. Herein, the control channel region is a region in which resource allocation information is transmitted and, more specifically, is a Physical Downlink Control Channel (PDCCH) region. Furthermore, the control channel region may be a control channel region conforming to fifth generation ( 5 G) standards, such as a New Radio-Physical Downlink Control Channel (NR-PDCCH) region in 5G.

(2) Interfering Resource Elements

The interfering resource elements are resource elements for which orthogonal encoding using the orthogonal codes for suppressing an interference that affects the target resource elements is performed. Specifically, the symbols of the ACK/NACK information encoded by the orthogonal codes are mapped to the interfering resource elements. Herein, the ACK/NACK information is ACK/NACK information for the uplink data received from the terminal apparatus 200 and, thus, the positions of the interfering resource elements are uniquely determined based on indexes or the like of the resource elements in which the uplink data has been transmitted.

The interfering resource elements include resource elements neighboring each target resource element in time direction and resource elements neighboring each target resource element in frequency direction. For example, in the example illustrated in FIG. 7, the interfering resource elements include a resource element neighboring each target resource element in time direction (two interfering resource elements) and a resource element neighboring each target resource element in time direction (one interfering resource element). Note that the interfering resource elements are not limited to the example in FIG. 7 but may further include, for example, resource elements each at a position one resource element shifted in time direction from the corresponding resource element neighboring each target resource element in frequency direction, and resource elements each at a position one resource element shifted in frequency direction from the corresponding resource element neighboring each target resource element in time direction.

(3) Operation of Terminal Apparatus

The terminal apparatus 200 (resource demapping section 431) extracts, from a signal received from the base station 100, the symbols of the ACK/NACK information for the uplink data mapped to the interfering resource elements causing the interference that affects each target resource element. The terminal apparatus 200 (orthogonal decoding section 433) decodes the symbols of the ACK/NACK information for the uplink data by the orthogonal codes for suppressing the interference that affects each target resource element.

(4) Flow of Process

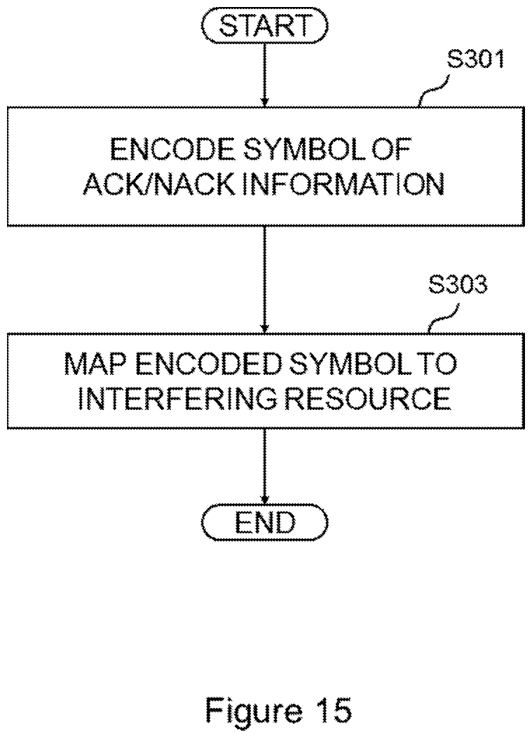

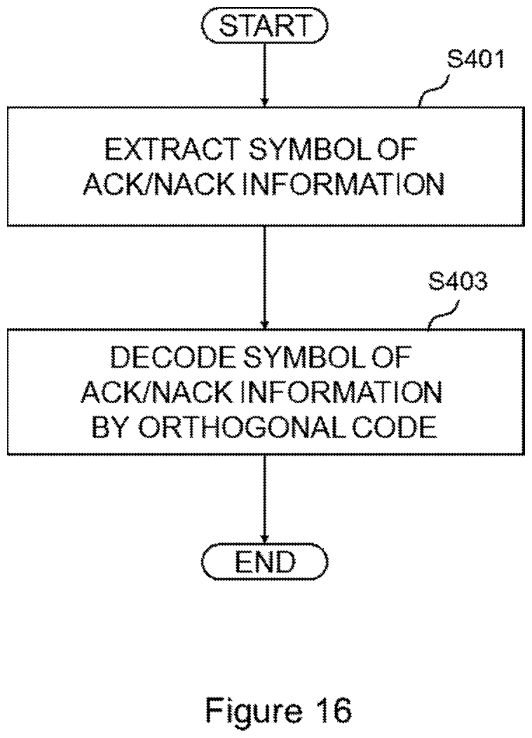

FIG. 15 is a flowchart for describing an example of a schematic flow of process in the base station 100 according to the second example embodiment.

The base station 100 (orthogonal encoding section 331) encodes symbols of ACK/NACK information for uplink data received from the terminal apparatus 200, by orthogonal codes for suppressing an interference that affects a target resource element (step S301). The base station 100 (resource mapping section 333) then maps the symbols encoded by the orthogonal codes to interfering resource elements causing an interference that affects the target resource elements (step S303).

FIG. 16 is a flowchart for describing an example of a schematic flow of process in the terminal apparatus 200 according to the second example embodiment.

The terminal apparatus 200 (resource demapping section 431) extracts, from a signal received from the base station 100, symbols of ACK/NACK information for uplink data mapped to interfering resource elements causing an interference that affects a target resource element (S401). The terminal apparatus 200 (orthogonal decoding section 433) decodes the symbols of the ACK/NACK information for the uplink data by orthogonal codes for suppressing the interference that affects the target resource elements (S402).

(5) Summary

As described above, positions of interfering resource elements are uniquely determined based on an index or the like of a resource element in which an uplink data has been transmitted. In other words, the interfering resource elements are uniquely determined and, thus, the terminal apparatus 200 can orthogonally decode the symbols mapped to the interfering resource elements without attempting to perform orthogonal decoding on symbols mapped to resource elements other than the interfering resource elements.

### 6. Third Example Embodiment

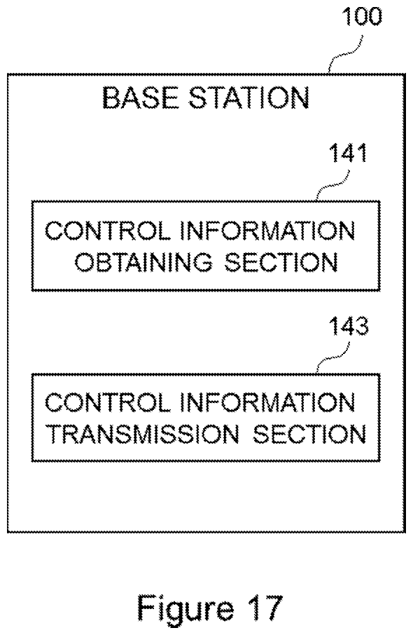

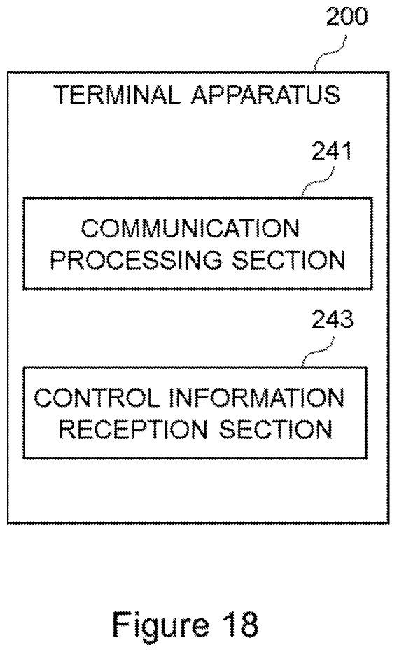

Next, a description will be given of a third example embodiment of the present invention with reference to FIG. 17 and FIG. 18. The above-described first example embodiment is a concrete example embodiment, whereas the third example embodiment is a more generalized example embodiment.

### <6.1. Configuration of Base Station>

With reference to FIG. 17, a description will be given of an example of a configuration of a base station 100 according to the third example embodiment. FIG. 17 is a block diagram illustrating an example of a schematic configuration of the base station 100 according to the third example embodiment. With reference to FIG. 17, the base station 100 includes a control information obtaining section 141 and a control information transmission section 143.

Concrete operations of the control information obtaining section 141 and the control information transmission section 143 will be described later in detail.

The control information obtaining section 141 and the control information transmission section 143 may each be implemented with a baseband (BB) processor, another processor and/or the like. The control information obtaining section 141 and the control information transmission section 143 may be implemented with the same processor or may be implemented with respective different processors.

The base station 100 may include a memory configured to store a program and one or more processors that can execute the program, and the one or more processors may perform operations of the control information obtaining section 141 and the control information transmission section 143. The program may be a program for causing the one or more processors to execute the operations of the control information obtaining section 141 and the control information transmission section 143.

### <6.2. Configuration of Terminal Apparatus>

With reference to FIG. 18, an example of a configuration of a terminal apparatus 200 according to the third example embodiment will be described. FIG. 18 is a block diagram illustrating an example of a schematic configuration of the terminal apparatus 200 according to the third example embodiment. With reference to FIG. 18, the terminal apparatus 200 includes a communication processing section 241 and a control information reception section 243.

Concrete operations of the communication processing section 241 and the control information reception section 243 will be described later in detail.

The communication processing section 241 and the control information reception section 243 may each be implemented with a baseband (BB) processor, another processor and/or the like. The communication processing section 241 and the control information reception section 243 may be implemented with the same processor or may be implemented with respective different processors.

The terminal apparatus 200 may include a memory configured to store a program and one or more processors that can execute the program, and the one or more processors may perform operations of the communication processing section 241 and the control information reception section 243. The program may be a program for causing the one or more processors to execute the operations of the communication processing section 241 and the control information reception section 243.

### <6.3. Technical Features>

Next, technical features of the third example embodiment will be described. The above-described first example embodiment is a concrete example embodiment, whereas the third example embodiment is a more generalized example embodiment.

The base station 100 (control information obtaining section 141 ) obtains control information related to the number of interfering resource elements that are subject to interference suppression for a target resource element. The base station 100 (control information transmission section 143) transmits the obtained control information to the terminal apparatus 200.

The terminal apparatus 200 (control information reception section 243) obtains the control information related to the number N of interfering resource elements. The terminal apparatus 200 (communication processing section 241) then performs communication with the base station 100 based on the control information.

As described above, communication of the control information from the base station 100 to the terminal apparatus 200 brings a common recognition of the number of interfering resource elements between the base station 100 and the terminal apparatus 200. This makes it possible to perform interference suppression for the target resource element more flexibly, for example, depending on required SINR and channel estimation accuracy. Specifically, in a case where the symbols orthogonally encoded by orthogonal codes for suppressing the interference that affects the target resource element are mapped to the interfering resource elements, the receiving side (the terminal apparatus 200 during downlink transmission, the base station 100 during uplink transmission) can easily identify the interfering resource elements to orthogonally decode the symbols mapped to the interfering resource elements. In a case where null symbols are mapped to the interfering resource elements, the receiving side (the terminal apparatus 200 during downlink transmission, the base station 100 during uplink transmission) can easily recognize the number of ineffective resource elements. Furthermore, in a case where the interference canceling signal is mapped to at least one of the interfering resource elements, the number of interfering resource elements is used as a factor for determining an average of transmission power to be distributed to the interference canceling signal during uplink transmission, thereby it will be possible to prevent transmission power from being distributed excessively to the interference canceling signal.

### 7. Fourth Example Embodiment

Next, a fourth example embodiment will be described. The above-described second example embodiment is a concrete example embodiment, whereas the fourth example embodiment is a more generalized example embodiment.

### <7.1. Configuration of Base Station>

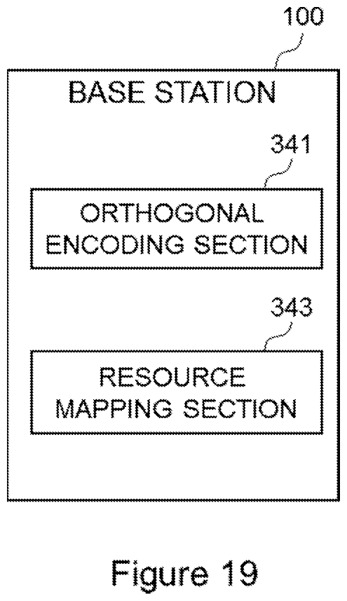

With reference to FIG. 19, a description will be given of an example of a configuration of a base station 100 according to the fourth example embodiment. FIG. 19 is a block diagram illustrating an example of a schematic configuration of the base station 100 according to the fourth example embodiment. With reference to FIG. 17, the base station 100 includes an orthogonal encoding section 341 and a resource mapping section 343.

Concrete operations of the orthogonal encoding section 341 and the resource mapping section 343 will be described later in detail.

The orthogonal encoding section 341 and the resource mapping section 343 may each be implemented with a baseband (BB) processor, another processor and/or the like. The orthogonal encoding section 341 and the resource mapping section 343 may be implemented with the same processor or may be implemented with respective different processors.

The base station 100 may include a memory configured to store a program and one or more processors that can execute the program, and the one or more processors may perform operations of the orthogonal encoding section 341 and the resource mapping section 343. The program may be a program for causing the one or more processors to execute the operations of the orthogonal encoding section 341 and the resource mapping section 343.

### <7.2. Configuration of Terminal Apparatus>

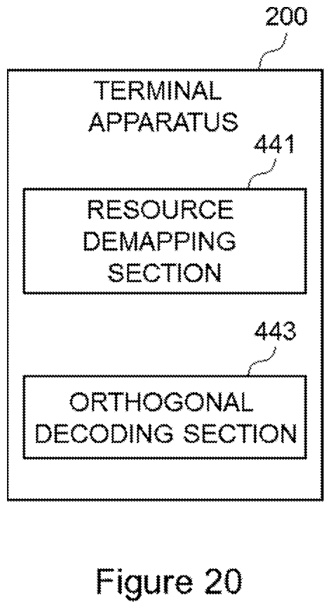

With reference to FIG. 20, an example of a configuration of a terminal apparatus 200 according to the fourth example embodiment will be described. FIG. 20 is a block diagram illustrating an example of a schematic configuration of the terminal apparatus 200 according to the fourth example embodiment. With reference to FIG. 20, the terminal apparatus 200 includes a resource demapping section 441 and an orthogonal decoding section 443.

Concrete operations of the resource demapping section 441 and the orthogonal decoding section 443 will be described later in detail.

The resource demapping section 441 and the orthogonal decoding section 443 may be implemented with a baseband (BB) processor, another processor and/or the like. The resource demapping section 441 and the orthogonal decoding section 443 may be implemented with the same processor or may be implemented with respective different processors.

The terminal apparatus 200 may include a memory configured to store a program and one or more processors that can execute the program, and the one or more processors may perform operations of the resource demapping section 441 and the orthogonal decoding section 443. The program may be a program for causing the one or more processors to execute the operations of the resource demapping section 441 and the orthogonal decoding section 443.

### <7.3. Technical Features>

Next, technical features of the fourth example embodiment will be described with reference to FIG. 19 to FIG. 20.

The base station 100 (orthogonal encoding section 341 ) encodes symbols of ACK/NACK information for uplink data received from the terminal apparatus 200, by orthogonal codes for suppressing an interference that affects a target resource element. The base station 100 (resource mapping section 343 ) then maps the symbols encoded by the orthogonal codes to interfering resource elements causing the interference that affects the target resource element.

The terminal apparatus 200 (resource demapping section 431) extracts, from a signal received from the base station 100, symbols of ACK/NACK information for an uplink data mapped to interfering resource elements causing an interference that affects a target resource element. The terminal apparatus 200 (orthogonal decoding section 433) decodes the symbols of the ACK/NACK information for the uplink data by the orthogonal codes for suppressing the interference that affects the target resource element.

The above-described ACK/NACK information is ACK/NACK information corresponding to uplink data received from the terminal apparatus 200. Thus, the positions of the interfering resource elements are uniquely determined based on an index or the like of a resource element in which the uplink data has been transmitted. The interfering resource elements are thus uniquely determined and, thus, the terminal apparatus 200 can orthogonally decode the symbols mapped to the interfering resource elements without attempting to perform orthogonal decoding for interfering resource elements on symbols mapped to resource elements other than the interfering resource elements.

Though example embodiments of the present invention have been described herein, the present invention is not limited to these example embodiments. It will be understood by those of ordinary skill in the art that these example embodiments are illustrative only and that various alterations can be done without departing from the scope and spirit of the present invention.

For example, the target resource element that is subject to the interference alleviation is not limited to the resource element to which the reference signal is mapped. Even in a case where a symbol other than the reference signal such as an information symbol is mapped to the target resource element, the interference that affects the target resource element can be alleviated.

This is applicable not only to the FBMC/OQAM scheme but to any communication scheme so long as symbols are mapped to non-orthogonal resource elements arranged in frequency direction and time direction.

A further step may be added to a process as a step in the process described in the present specification.

Moreover, an apparatus (for example, one or more apparatuses (or units) out of a plurality of apparatuses (or units) comprised in the base station) or a module (for example, a module for one of the plurality of apparatuses (or units)) including constituent elements of the base station described in the present specification may be provided. A module including constituent elements of the terminal apparatus described in the present specification may be provided. In addition, methods including processes of such constituent elements may be provided, and programs for causing processors to execute processes of such constituent elements may be provided. Furthermore, computer-readable non-transitory recording media (non-transitory computer readable media) having recorded thereon such programs may be provided. It is apparent that such apparatuses, modules, methods, programs and computer-readable non-transitory recording media are also included in the present invention.

Some or all of the above-described example embodiments can be described as in the following Supplementary Notes, but are not limited to the following.

### (Supplementary Note A1)

A base station comprising:

a control information obtaining section configured to obtain control information related to a number of interfering resource elements that are subject to interference suppression for a target resource element; and

a control information transmission section configured to transmit the control information to a terminal apparatus.

### (Supplementary Note A2)

The base station according to Supplementary Note A1, wherein the target resource element is a resource element to which a reference signal is mapped.

### (Supplementary Note A3)

The base station according to Supplementary Note A1 or A2, wherein the interference suppression is to map, to the interfering resource element, a symbol generated using an orthogonal code for suppressing an interference that affects the target resource element.

### (Supplementary Note A4)

The base station according to Supplementary Note A1 or A2, wherein the interference suppression is to map a null symbol with zero transmission power to the interfering resource element.

### (Supplementary Note A5)

The base station according to Supplementary Note A1 or A2, wherein the interference suppression is to map, to at least one resource element of the interfering resource elements, an interference canceling signal for canceling the interference that affects the target resource element.

### (Supplementary Note A6)

The base station according to any one of Supplementary Notes A1 to A5, wherein the interfering resource elements are resource elements located around the target resource element.

### (Supplementary Note A7)

The base station according to Supplementary Note A6, wherein the interfering resource elements include a resource element neighboring the target resource element in frequency direction and a resource element neighboring the target resource element in time direction.

### (Supplementary Note A8)

The base station according to Supplementary Note A7, wherein the interfering resource elements further include a resource element having a position one resource element shifted in time direction from the resource element neighboring the target resource element in frequency direction.

### (Supplementary Note A9)

The base station according to Supplementary Note A7, wherein the interfering resource elements further include a resource element having a position one resource element shifted in frequency direction from the resource element neighboring the target resource element in time direction.

### (Supplementary Note A10)

The base station according to Supplementary Note A6 or A7, wherein, in a case where the target resource element is located within a radio resource allocated to the terminal apparatus and not at an edge of the radio resource, the number of the interfering resource elements is 4 or 8.

### (Supplementary Note A11)

The base station according to Supplementary Note A6 or A7, wherein, in a case where the target resource element is located at an edge of a radio resource allocated to the terminal apparatus, the number of the interfering resource elements is 3 or 5.

### (Supplementary Note A12)

The base station according to any one of Supplementary Notes A1 to A11, wherein the control information is control information related both to the number of the interfering resource elements and a modulation and coding scheme.

### (Supplementary Note A13)

The base station according to Supplementary Note A12, wherein the number of the interfering resource elements is a number determined depending on a power ratio between a reference signal and a data symbol and/or a modulation and coding scheme.

### (Supplementary Note A14)

The base station according to Supplementary Note A12 or A13, wherein the control information is an index for identifying both the number of the interfering resource elements and the modulation and coding scheme.

### (Supplementary Note A15)

The base station according to Supplementary Note A14, wherein the control information is a Modulation and Coding Scheme (MCS) index.

### (Supplementary Note A16)

The base station according to any one of Supplementary Notes A1 to A15, wherein

the control information obtaining section is configured to obtain downlink control information including resource allocation information and the control information for the terminal apparatus, and

the control information transmission section is configured to transmit the downlink control information to the terminal apparatus.

### (Supplementary Note A17)

The base station according to any one of Supplementary Notes A1 to A15, wherein

the control information obtaining section is configured to obtain a MAC control element including the control information, and

the control information transmission section is configured to transmit the MAC control element to the terminal apparatus.

### (Supplementary Note A18)

The base station according to any one of Supplementary Notes A1 to A15, wherein

the control information obtaining section is configured to obtain an RRC message including the control information, and

the control information transmission section is configured to transmit the RRC message to the terminal apparatus.

### (Supplementary Note A19)

The base station according to Supplementary Note A18, wherein the RRC message is system information including the control information.

### (Supplementary Note A20)

The base station according to Supplementary Note A18, wherein the RRC message is a signaling message dedicated to the terminal apparatus and including the control information.

### (Supplementary Note A21)

A terminal apparatus comprising:

a control information reception section configured to receive, from a base station, control information related to a number of interfering resource elements that are subject to interference suppression for a target resource element; and

a communication processing section configured to perform wireless communication with the base station, based on the control information.

### (Supplementary Note A22)

A method comprising:

obtaining control information related to a number of interfering resource elements that are subject to interference suppression for a target resource element; and transmitting the control information to a terminal apparatus.

### (Supplementary Note A23)

A method comprising:

receiving, from a base station, control information related to a number of interfering resource elements that are subject to interference suppression for a target resource element; and

performing wireless communication with the base station, based on the control information.

### (Supplementary Note A24)

A program for causing a processor to execute:

obtaining control information related to a number of interfering resource elements that are subject to interference suppression for a target resource element; and

transmitting the control information to a terminal apparatus.

### (Supplementary Note A25)

A program for causing a processor to execute:

receiving, from a base station, control information related to a number of interfering resource elements that are subject to interference suppression for a target resource element; and

performing wireless communication with the base station, based on the control information.

(Supplementary Note A26)

A non-transitory computer-readable recording medium having recorded thereon a program for causing a processor to execute:

obtaining control information related to a number of interfering resource elements that are subject to interference suppression for a target resource element; and

transmitting the control information to a terminal apparatus.

### (Supplementary Note A27)

A non-transitory computer-readable recording medium having recorded thereon a program for causing a processor to execute:

receiving, from a base station, control information related to a number of interfering resource elements that are subject to interference suppression for a target resource element; and

performing wireless communication with the base station, based on the control information.

### (Supplementary Note B1)

A base station comprising:

an orthogonal encoding section configured to encode a symbol of ACK/NACK information for uplink data received from a terminal apparatus by an orthogonal code for suppressing an interference that affects a target resource element; and

a resource mapping section configured to map the symbol encoded by the orthogonal code to at least one interfering resource element causing an interference that affects the target resource element.

### (Supplementary Note B2)

The base station according to Supplementary Note B1, wherein the target resource element is located within a control channel region.

### (Supplementary Note B3)

The base station according to Supplementary Note B2, wherein the control channel region is a region in which resource allocation information is transmitted.

### (Supplementary Note B4)

The base station according to Supplementary Note B3, wherein the control channel region is a Physical Downlink Control Channel (PDCCH) region.

### (Supplementary Note B5)

The base station according to any one of Supplementary Notes B1 to B4, wherein the target resource element is a resource element to which a reference signal is mapped.

### (Supplementary Note B6)

The base station according to any one of Supplementary Notes B1 to B5, wherein the at least one interfering resource element is a resource element located around the target resource element.

### (Supplementary Note B7)

The base station according to Supplementary Note B6, wherein the at least one interfering resource element includes a resource element neighboring the target resource element in frequency direction and a resource element neighboring the target resource element in time direction.

### (Supplementary Note B8)

The base station according to Supplementary Note B7, wherein the at least one interfering resource elements further include a resource element having a position one resource element shifted in time direction from the resource element neighboring the target resource element in frequency direction.

### (Supplementary Note B9)

The base station according to Supplementary Note B7, wherein the at least one interfering resource elements further include a resource element having a position one resource element shifted in frequency direction from the resource element neighboring the target resource element in time direction.

### (Supplementary Note B10)

A terminal apparatus comprising:

a resource demapping section configured to extract, from a signal received from a base station, a symbol of ACK/NACK information for uplink data mapped to an interfering resource element causing an interference that affects a target resource element; and

an orthogonal decoding section configured to decode the symbol of the ACK/NACK information for the uplink data by an orthogonal code for suppressing an interference that affects the target resource element.

### (Supplementary Note B11)

A method comprising:

encoding a symbol of ACK/NACK information for uplink data received from a terminal apparatus by an orthogonal code for suppressing an interference that affects a target resource element; and

mapping the symbol encoded by the orthogonal code to at least one interfering resource element causing an interference that affects the target resource element.

### (Supplementary Note B12)

A method comprising:

extracting, from a signal received from a base station, a symbol of ACK/NACK information for uplink data mapped to an interfering resource element causing an interference that affects a target resource element; and

decoding the symbol of the ACK/NACK information for the uplink data by an orthogonal code for suppressing an interference that affects the target resource element.

### (Supplementary Note B13)

A program for causing a processor to execute:

encoding a symbol of ACK/NACK information for uplink data received from a terminal apparatus by an orthogonal code for suppressing an interference that affects a target resource element; and

mapping the symbol encoded by the orthogonal code to at least one interfering resource element causing an interference that affects the target resource element.

### (Supplementary Note B14)

A program for causing a processor to execute:

extracting, from a signal received from a base station, a symbol of ACK/NACK information for uplink data mapped to an interfering resource element causing an interference that affects a target resource element; and

decoding the symbol of the ACK/NACK information for the uplink data by an orthogonal code for suppressing an interference that affects the target resource element.

### (Supplementary Note B15)

A non-transitory computer-readable recording medium having recorded thereon a program for causing a processor to execute:

encoding a symbol of ACK/NACK information for uplink data received from a terminal apparatus by an orthogonal code for suppressing an interference that affects a target resource element; and

mapping the symbol encoded by the orthogonal code to at least one interfering resource element causing an interference that affects the target resource element.

### (Supplementary Note B16)

A non-transitory computer-readable recording medium having recorded thereon a program for causing a processor to execute:

extracting, from a signal received from a base station, a symbol of ACK/NACK information for uplink data mapped to an interfering resource element causing an interference that affects a target resource element; and

decoding the symbol of the ACK/NACK information for the uplink data by an orthogonal code for suppressing an interference that affects the target resource element.

This application claims priority based on Japanese patent application No. 2016-214086, filed on Nov. 1, 2016, the disclosure of which is incorporated herein in its entirety.

### INDUSTRIAL APPLICABILITY

Interference suppression for a single resource element can be more flexibly performed in a communication scheme in which symbols are mapped to resource elements arranged in frequency direction and time direction.

### REFERENCE SIGNS LIST

1 System
100 Base Station
110, 210, 310, 410 Wireless Communication Section
120, 220, 320, 420 Storage Section
130, 230, 330, 430 Processing Section
131, 231, 241 Communication Processing Section
133, 141 Control Information Obtaining Section
135, 143 Control Information Transmission Section
200 Terminal Apparatus
233, 243 Control Information Reception Section
331, 341 Orthogonal Encoding Section
333, 343 Resource Mapping Section
431, 441 Resource Demapping Section
433, 443 Orthogonal Decoding Section

1-43. (canceled)

44. A base station comprising:
a controller configured to:
obtain control information related to a number of interfering resource elements that are subject to interference suppression for a target resource element; and
transmit the control information to a terminal apparatus.

45. The base station according to claim 44, wherein the target resource element is a resource element to which a reference signal is mapped.

46. The base station according to claim 44, wherein the interference suppression is to map, to the interfering resource element, a symbol generated using an orthogonal code for suppressing an interference that affects the target resource element.

47. The base station according to claim 44, wherein the interference suppression is to map a null symbol with zero transmission power to the interfering resource element.

48. The base station according to claim 44, wherein the interference suppression is to map, to at least one resource element of the interfering resource elements, an interference canceling signal for canceling the interference that affects the target resource element.

49. The base station according to claim 44, wherein the interfering resource elements are resource elements located around the target resource element.

50. The base station according to claim 49, wherein the interfering resource elements include a resource element neighboring the target resource element in frequency direction and a resource element neighboring the target resource element in time direction.

51. The base station according to claim 50, wherein the interfering resource elements further include a resource element having a position one resource element shifted in time direction from the resource element neighboring the target resource element in frequency direction.

52. The base station according to claim 50, wherein the interfering resource elements further include a resource element having a position one resource element shifted in frequency direction from the resource element neighboring the target resource element in time direction.

53. The base station according to claim 49, wherein, in a case where the target resource element is located within a radio resource allocated to the terminal apparatus and not at an edge of the radio resource, the number of the interfering resource elements is 4 or 8.

54. The base station according to claim 49, wherein, in a case where the target resource element is located at an edge of a radio resource allocated to the terminal apparatus, the number of the interfering resource elements is 3 or 5.

55. The base station according to claim 44, wherein the control information is control information related both to the number of the interfering resource elements and a modulation and coding scheme.

56. The base station according to claim 55, wherein the number of the interfering resource elements is a number determined depending on a power ratio between a reference signal and a data symbol and/or a modulation and coding scheme.

57. The base station according to claim 55, wherein the control information is an index for identifying both the number of the interfering resource elements and the modulation and coding scheme.

58. The base station according to claim 57, wherein the control information is a Modulation and Coding Scheme (MCS) index.

59. The base station according to claim 44, wherein the controller is further configured to
obtain downlink control information including resource allocation information and the control information for the terminal apparatus, and
transmit the downlink control information to the terminal apparatus.

60. The base station according to claim 44, wherein the controller is further configured to
obtain a MAC control element including the control information, and
transmit the MAC control element to the terminal apparatus.

61. The base station according to claim 44, wherein the controller is further configured to
obtain an RRC message including the control information, and
transmit the RRC message to the terminal apparatus.

62. A terminal apparatus comprising:
a controller configured to:
receive, from a base station, control information related to a number of interfering resource elements that are subject to interference suppression for a target resource element; and
perform wireless communication with the base station, based on the control information.

63. A method comprising:
obtaining control information related to a number of interfering resource elements that are subject to interference suppression for a target resource element; and
transmitting the control information to a terminal apparatus.
